(19) United States
(12) Patent Application Publication
(10) Pub. No.: US 2009/0207180 A1
(43) Pub. Date: Aug. 20, 2009

(54) FPD for AIRCRAFT

(75) Inventors: Donald D. Jardee, Chesterland, OH (US); C. Jeffery Williams, Eastlake, OH (US)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignees: Heico Aerospace Company, Highland Heights, OH (US); Heico Corporation

(21) Appl. No.: 12/253,068

(22) Filed: Oct. 16, 2008

Related U.S. Application Data
(60) Provisional application No. 60/980,339, filed on Oct. 16, 2007.

(51) Int. Cl. G06F 15/80

(52) U.S. Cl. 345/505; 345/87

(57) ABSTRACT

A method and apparatus are provided for displaying information on a flat panel display. The method includes the step of providing a plurality of serial data sources, where each serial data source provides pixel data for display within a corresponding respective portion of the display where the respective corresponding portions are each discrete, incorporate a plurality of horizontal and vertical lines of pixel data and are non-overlapping. The method further includes the steps of reformatting and combining the data from the plurality of data sources into a single parallel data stream and displaying the reformatted data on the liquid crystal display.

### FIELD OF THE INVENTION

The field of the invention relates to aircraft and more particularly to the control displays present in the cockpit of an aircraft.

### BACKGROUND OF THE INVENTION

Electronic Flight Instrument Systems (EFIS) utilized a Cathode Ray Tube (CRT) to display information to the pilot are well known. The use of CRTs began in the early 1980's and continued until the early 2000's. In this time frame CRT's were the best technology available, replacing the mechanical Attitude Direction Indicator (ADI), the Horizontal Situation Indicator (HSI)/Navigation Situation Display, the Engine Indicating, Crew Alert System (EICAS) and other cockpit instruments. These CRT units were in general very reliable compared to the mechanical instruments they replaced.

CRTs have been used for information displays since the 1940's with monochrome and later with color CRTs. CRTs dominated all segments of the display market. Liquid Crystal Displays (LCD) began commercial success in the early 1990's, however; at that time LCDs in general were of poor quality. During the 1990's the quality issues were resolved making LCDs more and more popular. With the increase in screen resolution, consumer acceptance of early LCDs made them the display of choice. Today other technologies - including plasma screens and organic light emitting diodes (OLED) have joined LCDs in commercial success, under the general classification of Flat Panel Displays (FPDs). Manufacturers started reducing production of CRTs in the late 1990's, as the efficiency of LCD production increased thus reducing unit costs. The production of LCDs exceeded the production of CRTs in 2003. Since then the production of CRTs has dramatically declined making repair of CRT based units more and more difficult if not impossible, thus repairs are far more costly due to the declining production of CRTs.

Today, FPDs have replaced CRTs in the industrial and consumer market because of dramatic reliability and quality improvements. In the aviation industry, new production units are almost all FPD technology—from the smallest general aviation airplanes to the largest airliners. Because of the shift away from CRT technology production to FPD production in the commercial marketplace, the cost for replacement CRTs and early LCDs have risen dramatically, or the parts are no longer procurable. This is forcing aerospace OEMs to discontinue support for their CRT and early LCD display units. However, most aircraft utilizing CRT and early LCD technology are “young” or “midlife” aircraft, and have many years of service life remaining.

The LCD-based Display Units, with the exception of the LCD itself, are rugged electronics of the digital age and thusly robust and reliable. The LCDs are subject to bum-in and other failure modes. The LCD is, thus, the high failure items, requiring frequent maintenance to keep performance within functional limits. This makes replacing the early LCDs with an FPD “module” a perfect fit to continue operating the same display units without expensive aircraft modifications.

### SUMMARY

A method and apparatus are provided for displaying information on a flat panel display. The method includes the step of providing a plurality of serial data sources, where each serial data source provides pixel data for display within a corresponding respective portion of the display where the respective corresponding portions are each discrete, incorporate a plurality of horizontal and vertical lines of pixel data and are non-overlapping. The method further includes the steps of reformatting and combining the data from the plurality of data sources into a single parallel data stream and displaying the reformatted data on the liquid crystal display.

### BRIEF DESCRIPTION OF THE DRAWINGS

FIG. 1 is a block diagram of an avionics system for an aircraft shown generally in accordance with an illustrated embodiment of the invention;

FIG. 2 is a block diagram of the avionics system of FIG. 1;

FIG. 3 is a frame of pixels that may be displayed by the avionics system of FIG. 1; and

FIG. 4 is a wiring layout showing the components of FIG. 2..

### DETAILED DESCRIPTION OF AN ILLUSTRATED EMBODIMENT

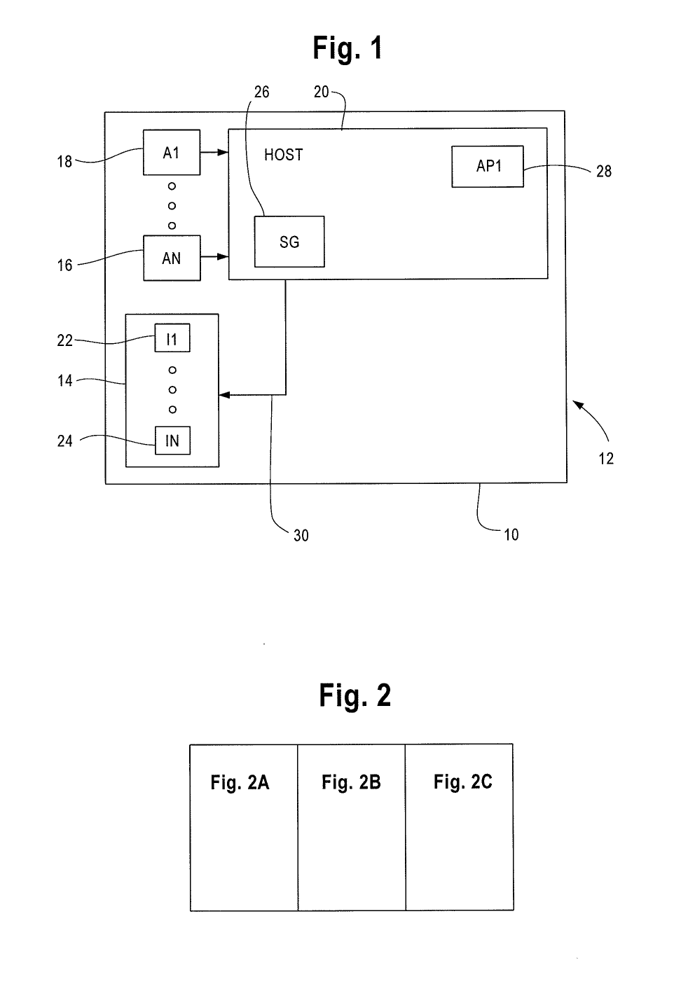

FIG. 1 is a block diagram of an EFIS avionics system 12 within an aircraft 10 shown generally in accordance with an illustrated embodiment of the invention. Within the avionics system 12, information about aircraft status (e.g., Attitude Direction Indicator (ADI), Horizontal Situation Indicator (HSI)/Navigation Situation Display, Engine Indicating, Crew Alert System (EICAS), etc.) is typically displayed to a pilot through a respective cockpit instrument 22, 24 on a display 14.

Each of the cockpit instruments 22, 24 may be provided as a separate graphical user interface (GUI) on the display 14. Cockpit instruments 22, 24 are typically displayed in predetermined locations on the display system 14.

As shown, one or more avionics sensor devices 16, 18 may collect data about the aircraft 10 and transfer the collected data to a respective avionics processor 26 with a host 20. Within the avionics processor 26, the data may be reformatted and combined with other data to generate status information for respective cockpit instruments 22, 24. The status information may, in turn, be coupled to a respective symbol generator 26 that interacts with the corresponding cockpit instrument 22, 24.

Communication between the respective symbol generators 26 and corresponding cockpit instrument 22, 24 is typically packet based that is transmitted to the display 14 through a computer bus 30. In general, the host 20 supports a number of independent processes equal to the number of instruments 22, 24 shown on the display 14, where each independent process of the cockpit instrument 22, 24 receives data from the respective symbol generator 26 at a separate system address.

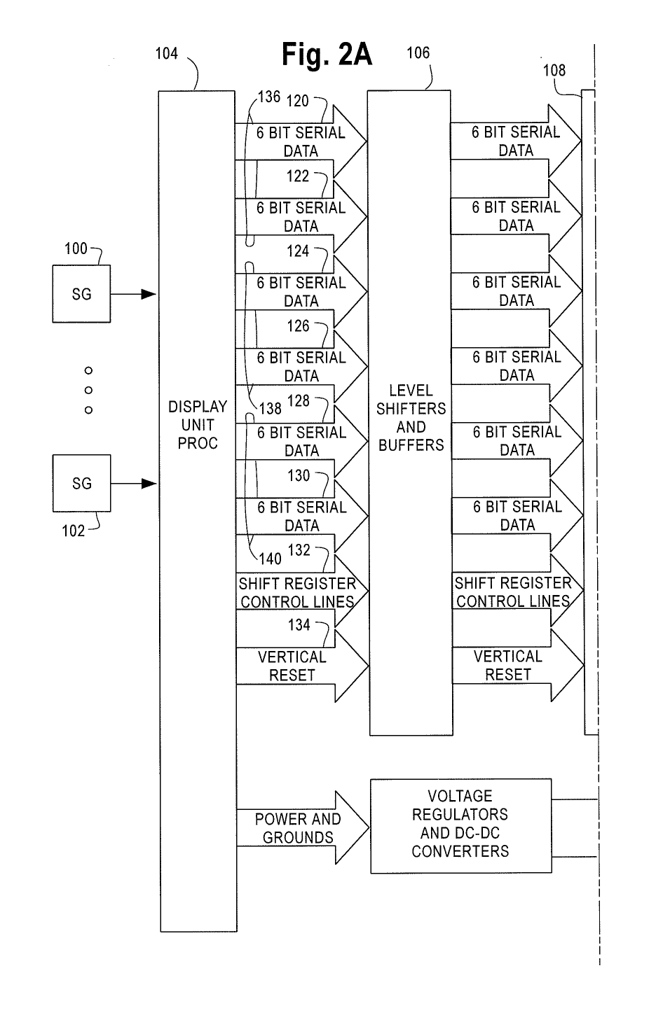

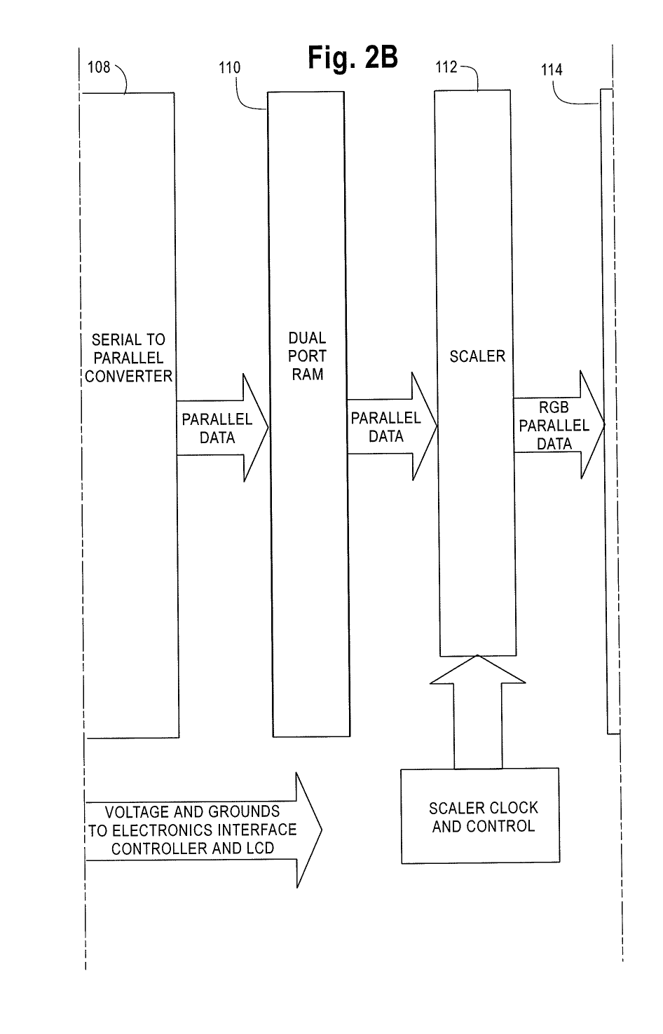

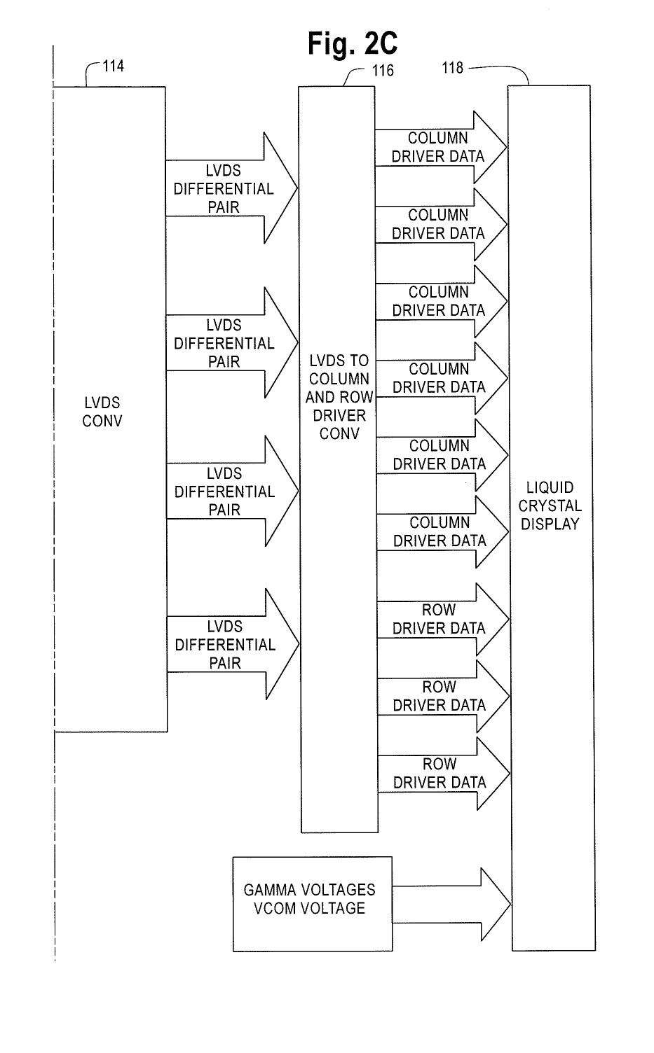

FIG. 2 is a block diagram of the display 14. FIG. 4 is a conductor layout showing the components of FIG. 2. As shown, a display unit processor 104 receives information from the respective symbol generators 26 (now labeled symbol generator 100 and 102 in FIG. 2) and combines the data for presentation on the display 118.

Under illustrated embodiment, the data from the symbol generators 100, 102 may be formatted and combined into a visual format (i.e., pixel information) and provided in the form of a number of serial data streams 120, 122, 124, 126, 128, 130 based upon screen location. For example, the six data streams 120, 122, 124, 126, 128, 130 may be assembled into three data sources 136, 138, 140 of two data streams each. The three data sources 136, 138, 140 may simultaneously provide data intended for three respective, predetermined, non-overlapping portions of the display screen 118.

Each of the data streams 120, 122, 124, 126, 128, 130 may simultaneously provide six bits of pixel data in a repeating format of red, green and blue (RGB). That is, the data stream may first provide six bits of data defining an instantaneous brightness of a red portion of the pixel, followed by six bits of data that define an instantaneous brightness of a green portion of the pixel, followed by six bits of data that define a blue portion of the pixel.

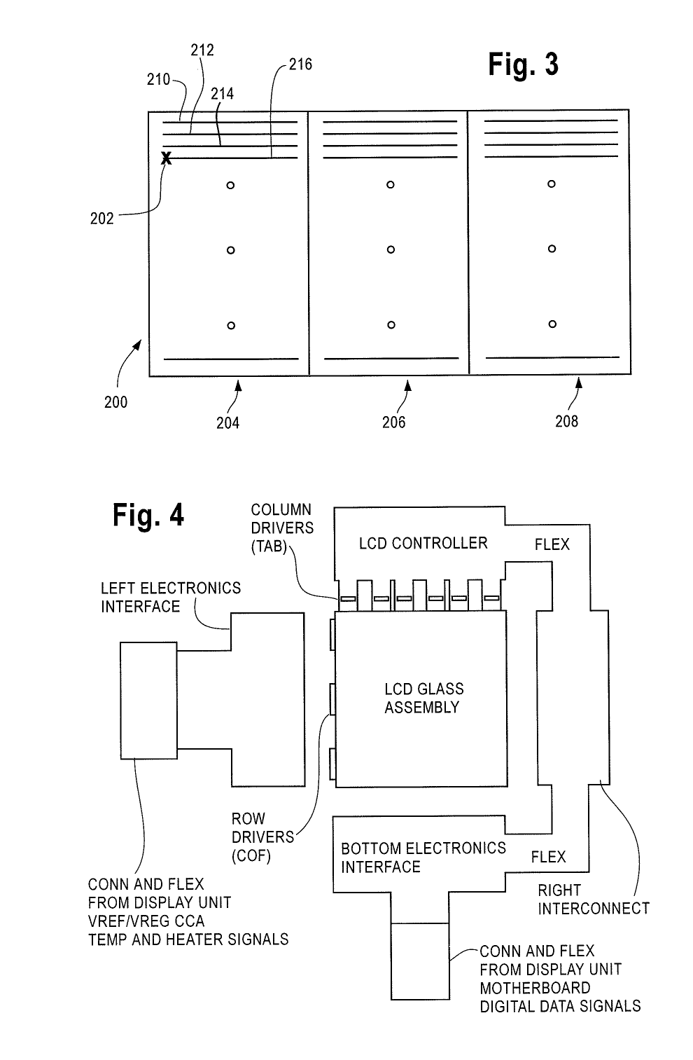

The first data source 136 including data streams 120, 122 may provide pixel data for a first set of pixels located within a first predetermined portion of the display 118. For example, FIG. 3 depicts a frame 200 of pixel data that may be shown on the display 118 of FIG. 2. In this case, the first set of pixels 202 are intended to occupy a first predetermined area 204 (e.g., a left one-third of the display 118). The two data streams 120, 122 may contain pixel data intended for the area 204 under an alternating interleaved format. For example, data stream 120 may provide data intended for a first line (or column) 210, while the data stream 122 provides data intended for a second line (or column) 212. Similarly, while data stream 120 provides data intended for a third line (or column) 214, data stream 122 provides data intended for a fourth line (or column) 216. The data source 136 continuously writes pixel data into the area 204 from top to bottom. Once the data source 136 reaches the bottom, a reset signal is generated and the data source may again begin writing data from the top.

While the first data source 136 provides data intended for the first area 204, the second data source 138 including data streams 124, 126 may provide pixel data into a second predetermined area 206 (e.g., a second one-third of the screen 118). As with the first data source 136, the second data source 138 may provide pixel data for the second area 206 under an interleaved format where the first data stream 124 may provide pixel data for a first set of alternating lines (e.g., the odd numbered lines) of pixels from top to bottom while the second data stream 126 provides pixel information for a second set of interleaved lines (e.g., the even numbered lines).

Similarly, while the first and second data sources 136, 138 provide pixel data for the first and second predetermined areas 204, 206, the third data source 140 provides pixel information for a third predetermined area 208 (e.g., the right one-third of the screen 118). As with the first and second data source 136, 138, the third data source 140 may provide pixel data for the third area 208 under an interleaved format where the first data stream 128 may provide pixel data for a first set of alternating lines (e.g., the odd numbered lines) of pixels from top to bottom while the second data stream 130 provides pixel information for a second set of interleaved lines (e.g., the even numbered lines).

The pixel information of the three data sources 136, 138, 140 may first be buffered and converted within a converter processor 106. Within the converter processor 106, the logic levels of the host 20 (e.g., 5 volts) may be converted to a lower voltage level (e.g., 3.3 volts) that are more easily handled by the display 118.

Buffering may be controlled by a set of shift register control lines 132. Buffering may be by pixel or by row or by multiples of rows. A vertical reset 134 is also provided to synchronize the buffering with frame position.

From the converter processor 108, the pixel data of the three data sources 136, 138, 140 is converted from a serial to a parallel format within a serial to parallel processor 108. Within the serial to parallel processor 108, the serial data for each portion of a row (or, alternatively, into a column) of the display 118 may be concatenated under control of signals from the shift register control lines and vertical reset into a sequence of pixel values that define a complete row or column on the display 118. As the pixel values are concatenated into a complete row or column, the pixel values are sent to a dual port ram 110.

Within the dual port ram 110, a full line (or column) of pixel information is accumulated. It should be noted in this regard that each pixel has three colors values (i.e., red, green and blue). However, the red, green and blue would not all be on one row of the display. Instead, a first pixel would have a red and green element on the first line, followed by the blue of the next succeeding pixel. On the next line, the blue of the first pixel would be followed immediately by the red and green elements of the second pixel. Accordingly, the serial to parallel processor 108 writes pixel data into the RAM 110 in accordance with this sequence. In order to write pixel data into the RAM 110 in accordance with this sequence, the serial to parallel converter 108 must buffer the information of at least one full pixel from each data stream 120, 122, 124, 126, 128, 130. In the example above where the red and green are on a first line, the serial to parallel processor 108 would need to write the red and blue values into the RAM 110, immediately, and buffer the blue value for the pixel until the next line. Similarly, if the blue value of a pixel were written on a first line, then the red and green would be buffered for entry into the next line.

As each line is completed within the RAM 110 by the serial to parallel processor 108, the line is transferred to an output of the RAM 110. The pixel value(s) of each line are maintained on the output of the RAM 110 for access by a scaling processor 112 as a new line of pixel information is written into the input to the RAM 110.

Within the scaling processor 112, the pixel information may be scaled to fit the display 118. For example, the frame 200 of pixel data produced by the serial to parallel processor 108 may have 768 pixels in each horizontal row (768H) and 576 pixel in each vertical column or row (576V) at a 58 Hz frame rate. The data may be processed by the provided to the scaling processor 112 at a 15 MHz clock rate. Within the scaling processor 112, the pixel data stream may be converted to a 768H by 768V frame at a 60 Hz frame rate.

Expanding, in this case, means adding new pixels into the line of pixel data. In the case of a conversion from 576V to 768V, the conversion would involve adding a new line or row of pixels for every one and one-third vertical pixels and vertically averaging the pixel color values.

The output of the scaling processor 112 is also RGB parallel data. The RGB data is output to a LVDS processor 114. Within the LVDS processor 114, the RGB parallel pixel data is converted into a number of low voltage differential signaling (LVDS) pairs that are, in turn, applied to a LVDS to column and row driver converter processor 116. The converter processor 116, in turn, drives the pixels of the individual rows and columns of the display 118.

A specific embodiment of method and apparatus for providing a cockpit display for an aircraft has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method for displaying information on a flat panel display comprising:
providing a plurality of serial data sources, where each serial data source provides pixel data for display within a corresponding respective portion of the display where the respective corresponding portions are each discrete, incorporate a plurality of horizontal and vertical lines of pixel data and are non-overlapping;
reformatting and combining the data from the plurality of data sources into a single parallel data stream; and
displaying the reformatted data on the liquid crystal display.

2. The method for displaying information as in claim 1 wherein the plurality of data sources further comprises a first data source for a left column covering a first one-third of the display, a second data source for a second one-third of the display and a third data source for a third one-third column of the display.

3. The method for displaying information as in claim 2 wherein the first, second and third data sources further comprise separate first and second data streams defining lines of pixels on the display where each line of pixels of the second stream is interleaved between corresponding lines of the second data stream and visa versa.

4. The method for displaying information as in claim 2 wherein the plurality of serial data sources further comprise a separate data value for red, green and blue pixels.

5. The method for displaying information as in claim 1 further comprising scaling the display.

6. The method for displaying information as in claim 1 further comprising level shifting the data from each of the plurality of data sources from 5 volts to 3 volts.

7. The method for displaying information as in claim 1 wherein the step of reformatting and combining further comprises converting the single parallel data stream to a low voltage differential signaling format.

8. An apparatus for displaying information on a flat panel display comprising:
means for providing a plurality of serial data sources, where each serial data source provides pixel data for display in a corresponding respective portion of the display where the respective corresponding portions are each discrete, incorporate a plurality of horizontal and vertical lines of pixel data and non-overlapping;
means for reformatting and combining the data from the plurality of data sources into a single parallel data stream; and
means for displaying the reformatted data on the liquid crystal display.

9. The apparatus for displaying information as in claim 8 wherein the plurality of data sources further comprises a first data source for a left column covering a first one-third of the display, a second data source for a second one-third of the display and a third data source for a third one-third column of the display.

10. The apparatus for displaying information as in claim 9 wherein the first, second and third data sources further comprise separate first and second data streams defining lines of pixels on the display where each line of pixels of the second stream is interleaved between corresponding lines of the second data stream and visa versa.

11. The apparatus for displaying information as in claim 9 wherein the plurality of serial data sources further comprise a separate data value for red, green and blue pixels.

12. The apparatus for displaying information as in claim 8 further comprising means for scaling the display.

13. The apparatus for displaying information as in claim 8 further comprising means for level shifting the data from each of the plurality of data sources from 5 volts to 3 volts.

14. The apparatus for displaying information as in claim 8 wherein the step of reformatting and combining further comprises converting the single parallel data stream to a low voltage differential signaling format.

15. An apparatus for displaying information on a flat panel display comprising:
a plurality of serial data sources, where each serial data source provides pixel data for display in a corresponding respective portion of the display where the respective corresponding portions are each discrete, incorporate a plurality of horizontal and vertical lines of pixel data and non-overlapping;
a series to parallel processor that reformats and combines the data from the plurality of data sources into a single parallel data stream; and
a display that displays the reformatted data on the liquid crystal display.

16. The apparatus for displaying information as in claim 15 wherein the plurality of data sources further comprises a first data source for a left column covering a first one-third of the display, a second data source for a second one-third of the display and a third data source for a third one-third column of the display.

17. The apparatus for displaying information as in claim 16 wherein the first, second and third data sources further comprise separate first and second data streams defining lines of pixels on the display where each line of pixels of the second stream is interleaved between corresponding lines of the second data stream and visa versa.

18. The apparatus for displaying information as in claim 16 wherein the plurality of serial data sources further comprise a separate data value for red, green and blue pixels.

19. The apparatus for displaying information as in claim 15 further comprising a scaling processor that scales the display.

20. The apparatus for displaying information as in claim 15 further comprising a level shifting processor that level shifts the data from each of the plurality of data sources from 5 volts to 3 volts.
